(19) United States
(12) Patent Application Publication
(10) Pub. No.: US 2022/0021711 A1
(43) Pub. Date: Jan. 20, 2022

(54) Security Platform and Method for Efficient Access and Discovery

(71) Applicant: CGI FEDERAL, Fairfax, VA (US)

(72) Inventors: Jason H. Marsh, Haymarket, VA (US); Venkatasubramanian J. Kodumudi, Ashburn, VA (US); Tariq Ul Islam, Fairfax, VA (US); Gordon Ng, Fairfax, VA (US); William Hudson Sutherland, III, Haymarket, VA (US); Mark James Thompson, Lafayette, LA (US); Christopher Vladimir Kalian, Herndon, VA (US); Zachary Tate Sarver, Tazewell, VA (US); Thomas Alexander Reynolds, Bristow, VA (US); Ahamed Mohammed Jemal, Atlanta, GA (US); Shawn Porché Morris, Broussard, LA (US); Rohan Nikhil Koduri, Suffolk, VA (US); Sumit Jitendra Shah, Herndon, VA (US); Hriday Rameshchandra Keni, Springfield, VA (US); Cameron Francis Skaff, Arlington, VA (US)

(73) Assignee: CGI FEDERAL, Fairfax, US (US)

(21) Appl. No.: 17/380,181

(22) Filed: Jul. 20, 2021

Related U.S. Application Data
(60) Provisional application No. 63/054,225, filed on Jul. 20, 2020.

(51) Int. Cl. H04L 29/06; G06F 21/60; G06F 21/62; H04L 9/32; G06F 16/903

(52) U.S. Cl. CPC H04L 63/20; G06F 21/602; H04L 2209/38; H04L 9/3247; G06F 16/90335; G06F 21/62

(57) ABSTRACT

A secure data fabric (SDF) can include a security platform for sharing data, access and discovery of data, and audit traceability, across disparate data stores and networks. A SDF can leverage blockchain with attribute-based access control (ABAC). A SDF platform can include an immutable data storage medium, a data sharing node, a central processing unit, and memory having software, which can be configured to implement a blockchain and an ABAC module. The immutable data storage medium can be part of a network. The immutable data storage medium can be immutable off-chain data storage for the SDF, and a multi-layered ABAC security policy can be implemented for the SDF. The SDF can have a cross-domain topology model. A multi-party workflow for account keys and digital signatures management can be further implemented. A microservices-based access control module can be configured to dynamically evaluate digital security policies for a secure data fabric.

### TECHNICAL FIELD

The present invention relates to a security platform for sharing data and efficient access and discovery of data across an organization and/or inter-organizationally, while providing robust audit traceability.

### BACKGROUND

Information security is an increasingly widespread and important concern. It typically involves preventing unauthorized access to data, as well as unauthorized disclosure, deletion, corruption, and modification of information. In modern digital environments, these aspects are exponentially more concerning.

### SUMMARY

The present invention is generally directed to a security platform and method for sharing data and efficiently controlling access and discovery of data across an organization and/or cross-organizations, while providing robust data lineage and audit traceability. A computer system executing the method can be directed by a program stored on a non-transitory computer-readable medium. Multi-port interfaces and distributed computing, among other related technologies, can be utilized.

An aspect can include a security platform. A security platform can include an immutable data storage medium, a data sharing node, a central processing unit, and memory. The immutable data storage medium can be communicatively coupled to a network. The data sharing node can be communicatively coupled to the network. The memory can include software. The software can be configured to implement a blockchain and an attribute-based access control (ABAC) component.

Embodiments can include a secure data fabric (SDF), which can be based on a cross-domain topology model. A user management module can be included. The user management module can be a sub-module and/or can be utilized for facilitating user attributes that are specific to a SDF. Such module can be configured to control user attributes of a secure data fabric.

Embodiments can include an administrative console, which can be configured to manage blockchain-authorization-based data sharing control and/or access policies and to control ABAC policies of the network. The ABAC policies can include a multi-layered ABAC security policy. A SDF administrative console can be utilized to configure an organization's ABAC policies on a SDF network. A SDF administrative console can be utilized to define an organization's domain boundaries and/or cross-domain policies for data access, for example where such is necessary for networked use of application functionality.

The immutable data storage medium can be separate from the blockchain. In some embodiments, the immutable data storage medium and the data sharing node can be stored within a single location, such as a server or serverless container. In other embodiments, one or both of the immutable data storage medium and the data sharing node can be stored at multiple locations across the network.

Some embodiments can include a data discovery search interface and/or a microservices-based application programming interfaces (APIs) access control module. A microservices-based APIs access control module can be configured to dynamically evaluate digital security policies for a secure data fabric.

Embodiments can include a security platform for sharing data and efficient access and discovery of data across an organization and/or inter-organizationally, while providing robust audit traceability. For example, some embodiments can include an audit module. Such module can be configured to trace data lineage and/or data authenticity. The audit module can be configured to generate an audit trail. Such audit trail can include various data, such as access authorization throughout the network. The audit trail functionalities can be configured to track of access authorization for transactions, records, and other network activity at any place in a network and/or through a string of networks and hosts.

Some embodiments can include a policy framework object model for data sharing on a SDF. The SDF can be implemented as a cross-domain topology model. The immutable data storage medium can be immutable off-chain data storage for the SDF, and a multi-layered ABAC security policy can be implemented for the SDF. A multi-party workflow for account keys and digital signatures management can be further implemented. A microservices-based access control model can be implemented to dynamically evaluate digital security policies for the SDF. Embodiments can include a cryptographic module. A cryptographic module can be configured to sign an atomic data transaction using a private-public key pair. A cryptographic module can be configured to achieve non-repudiation based on, for example, a digital signature.

Yet other embodiments can include an end-user interface and a smart contract module. The end-user interface can be utilized to create and manage a smart contract. The interface can be configured to manage the smart contract for data sharing.

An aspect can include a blockchain-based method for implementing a secure data fabric. The method can include providing an immutable data storage medium, providing a data sharing node, and implementing an attribute-based access control to create a secure data sharing environment. The immutable data storage medium can be configured to communicate with a network. The data sharing node can be configured to communicate with the network

Some embodiments can further include storing data access policies and/or metadata in the immutable data storage medium. Data associated with the metadata can be stored in the data sharing node according to the data access policies. The data access policies can be ABAC policies and/or include a multi-layered ABAC security policy. The method can include evaluating access to the data using the multi-layered ABAC security policy.

In other embodiments, the method can include generating an audit trail of access authorization in the network. The method can include cryptographically signing an atomic data transaction using a private-public key pair.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 shows illustrative components of a SDF data sharing node.

FIG. 2 depicts a user interface illustrating configuration of blockchain node for data sharing.

FIG. 3 depicts a user interface for setting detailed ABAC policy management.

FIG. 4 depicts a secure data fabric (SDF) data discovery search interface.

FIG. 5 illustrates an architecture for a SDF.

FIG. 6 depicts a user interface for smart contract management.

FIG. 7 illustrates a cross-domain topology model for a SDF.

FIG. 8 illustrates a SDF policy framework object model.

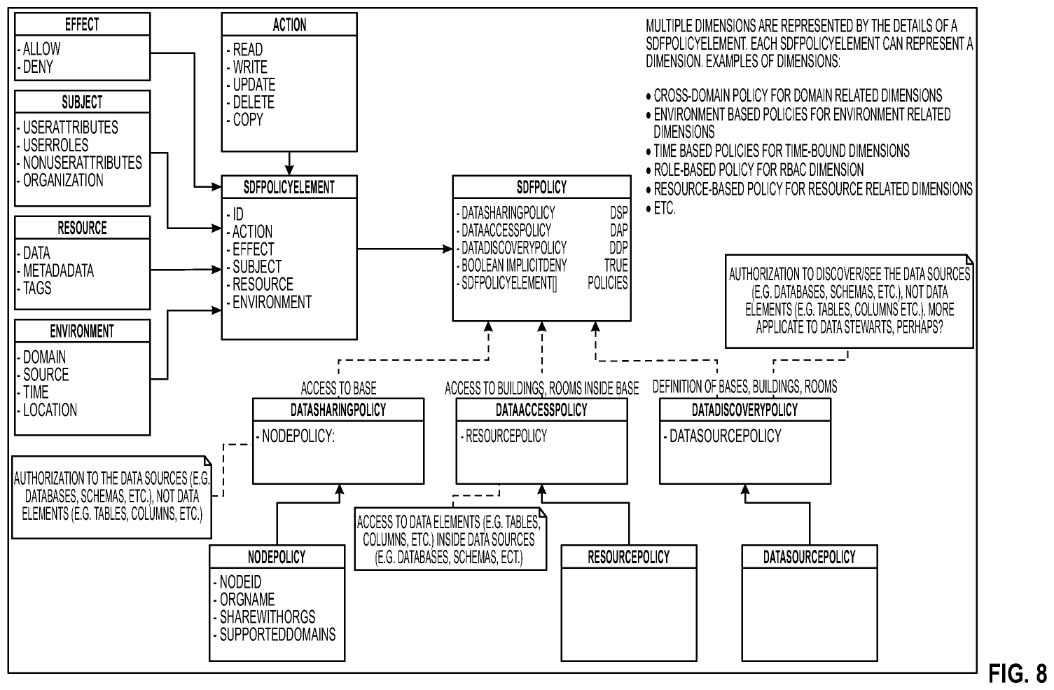

FIG. 9 illustrates authorization steps.

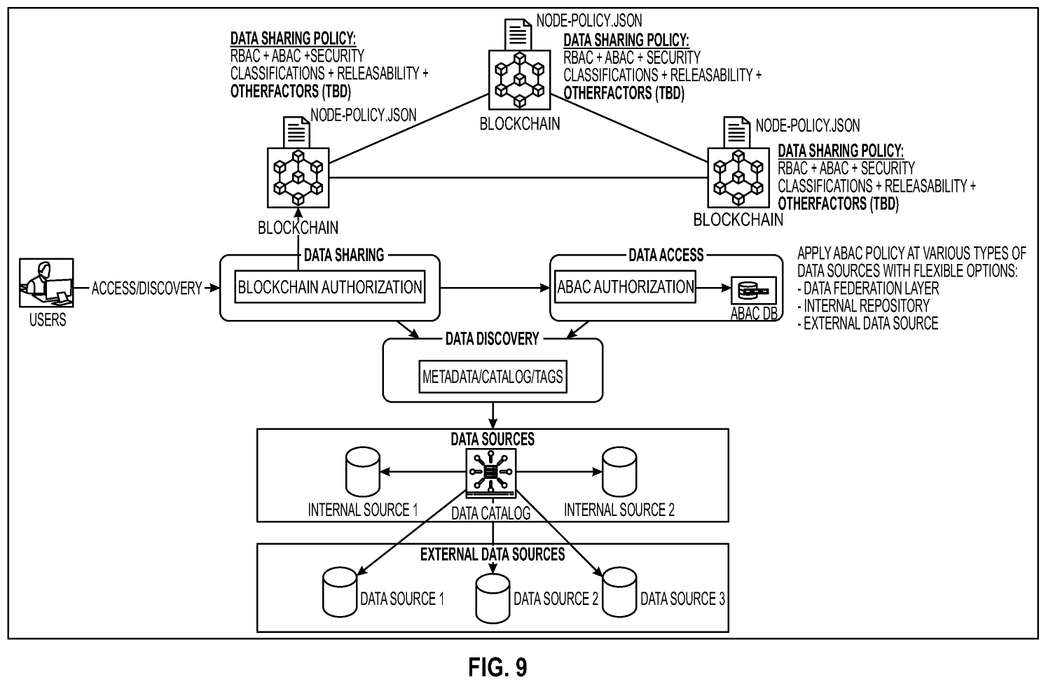

FIG. 10 illustrates a handshaking flow diagram.

FIG. 11 illustrates a high-level example of single sign on (SSO).

FIG. 12 illustrates creating a data sharing policy.

FIG. 13 illustrates a data sharing authorization process.

FIG. 14 illustrates a workflow for data sharing.

FIG. 15 illustrates a workflow for requirement, fulfillment, and approval.

FIG. 16 illustrates a workflow for account keys and digital signatures management.

FIG. 17 illustrates a SDF component for immutable off-chain data storage.

FIG. 18 illustrates an asynchronous messaging queue process.

FIG. 19 illustrates a multi-layered ABAC security policy.

FIG. 20 illustrates a data discovery component.

FIG. 21 depicts an audit visualization tool.

### DETAILED DESCRIPTION

A detailed explanation of the system, method, and exemplary embodiments of the present invention are described below. Exemplary embodiments described, shown, and/or disclosed herein are not intended to limit any claim, but rather, are intended to instruct one of ordinary skill in the art as to various aspects of the invention. Other embodiments can be practiced and/or implemented without departing from the scope and spirit of the invention.

Embodiments can include a secure data fabric (SDF). A SDF can include a security platform for sharing data, and efficient access and discovery of data across an organization and/or cross-organizations, while providing robust audit traceability. SDF can create a secure data sharing environment across disparate data stores and networks. SDF can leverage blockchain with attribute-based access control (ABAC) to create the secure data sharing environment. SDF can achieve this by, for example, allowing data discovery, and validating user permissions to access, without the need for duplicating data and sacrificing data integrity, authority, and/or non-repudiation.

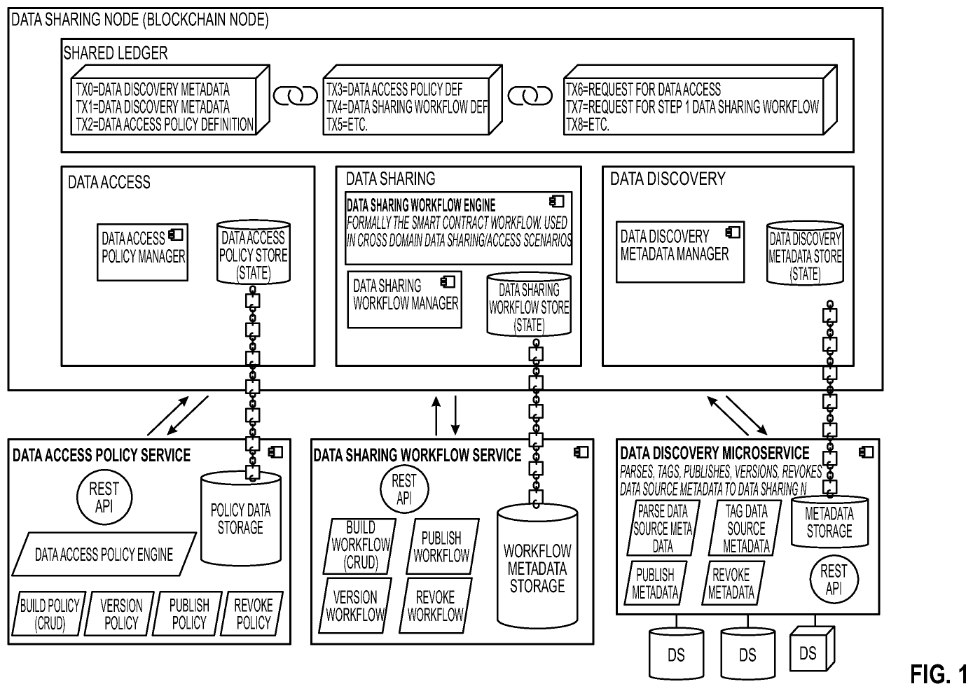

FIG. 1 illustrates an exemplary embodiment, details of which are discussed throughout herein. In sum, the figure depicts a logical view of interactions via application programming interfaces (APIs) between various components of a SDF. Such components can include a shared ledger; modules for data access, data sharing, and data discovery; services such as data access policy and data sharing workflow; data discovery microservices such as parsing, tagging, publishing, versioning, and revocation; and others. Various advantages can be achieved from embodiments. For example, blockchain and ABAC can be combined as described herein to improve system performance and speed. Further, the system can allow for full auditability, which can be further enhanced via decentralization and/or an immutable database (which can be implemented off of a main chain). In some embodiments, only hash or metadata data is on the chain while data the main data (big size files, images, voice, video) can be maintained on the off-chain immutable data storage. The hash or metadata transaction on the-chain points to the off-chain data storage thus keeping the traceability intact and providing a verifiable audit trail. Such off-chain data storage can significantly improve performance, processing times, and storage requirements.

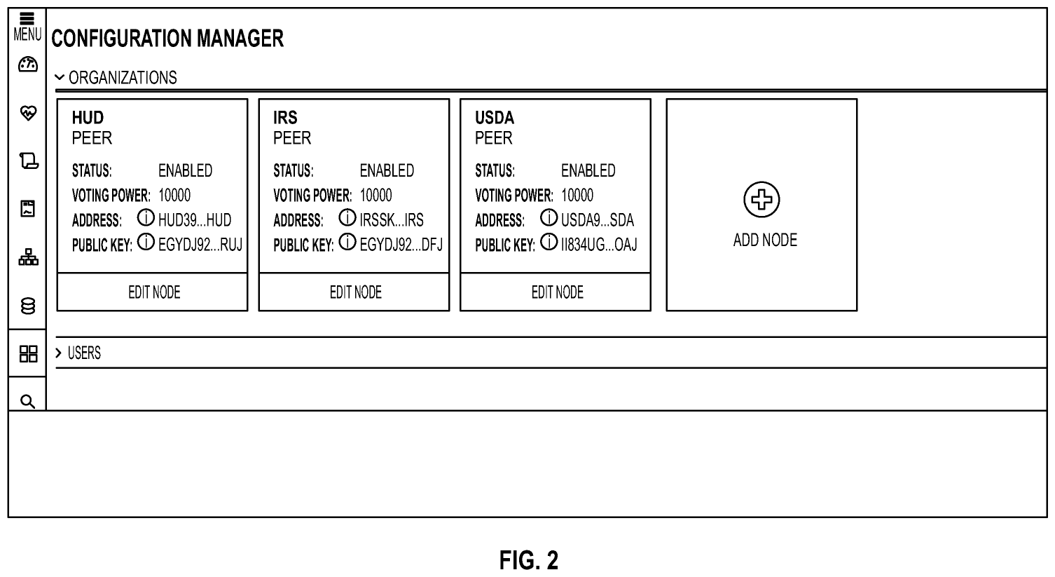

FIG. 2 depicts a user interface illustrating blockchain node for data sharing. A SDF can be capable of securing each data element within the data environment. SDF can use a microservices-based access control model to dynamically evaluate digital security policies, for example as compared against relevant attribute values. A SDF can determine whether to authorize a request for data in real time. SDF can decouple authentication from authorization and evaluate user data requests against predefined ABAC policies. As an example, users can be allowed only to access or view data elements (e.g., columns, rows, or cells) within a relational database table or view data elements, if they have been assigned the appropriate attributes for a given security context. Security contexts can be specific to different environments, domains, IP addresses, geographical physical location and organizations. For example, they can be defined by sets of attributes that can be set by an organization. Such functions together can provide a secure data sharing platform that allows organizations and data owners to maintain full control of their data without the need for a centralized single-party-controlled data repository.

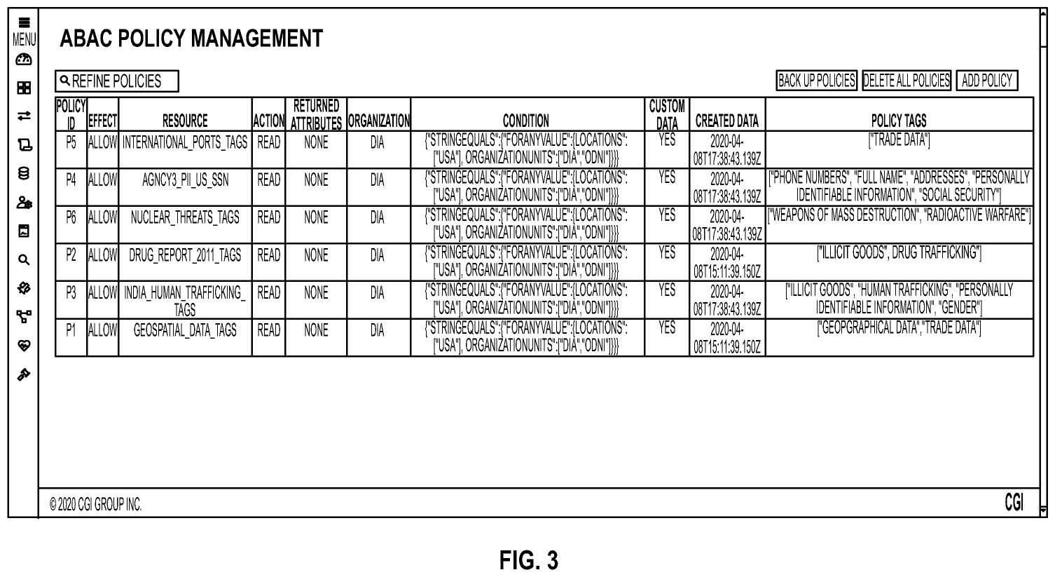

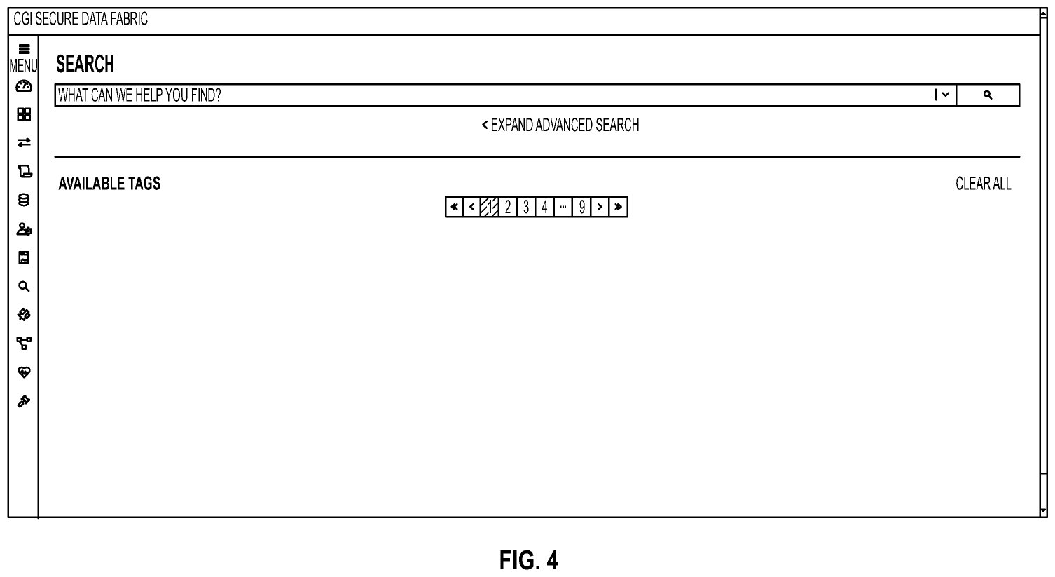

SDF can include software that can be downloaded and/or installed (on premises, via a cloud, hybrid model (on premise and cloud combined) and/or via a network, such as a network of computers). Such SDF can be configured for use by an organization to provide secure data sharing and access controls for data users with access to the organization's network. FIGS. 2 and 3 depict examples of user interfaces for a SDF. FIG. 3 depicts a user interface that can set detailed ABAC policy management. FIG. 4 depicts a data discovery search interface for a SDF. A SDF interface can be an administrative console, which can allow tiers of administrative access to the software. Tiers of access can allow definition and implementation of various controls imposed by the software. System owners, IT owners and data owners (as determined by policy, by preference, etc.) can use an administrative console to configure blockchain-authorization-based data sharing security control and access policies that can allow an organization to define how to share data with authorized data users while denying access to unauthorized data users. Owner, herein, refers generally to those typically in the role of systems, IT, etc., but is not used to limit any aspect to a particular role, person, group, system or entity. Through a SDF administrative console, a system owner can configure the organization's ABAC polices that define detailed access permissions to control who can create, modify, transfer, or access data residing on the network. SDF can also be configured to integrate with the organization's business applications through the administrative console and/or by invoking a REST API in the code, for example where data sharing and access across applications is required. IT owners can use a SDF administrative console to define domain boundaries and/or cross-domain policies for data access that may be necessary for networked use of application functionality. They can also manage the blockchain network while monitoring and/or analyzing audit trail data.

A REST API-based integration and/or web-based configurations can enable application owners to manage SDF for their applications, for example. Although not required, each SDF capability can be achieved with a distinct technology (such as blockchain and ABAC) and corresponding sets of tools (such as blockchain implementation, ABAC framework, and/or data catalog audit visualization).

Many capabilities are contemplated for a SDF. For example, blockchain-enabled software can securely manage access to a permissioned network of multiple disparate data sources with known identities. The SDF offers capabilities to leverage different blockchain protocols (e.g. Tendermint, Hyperledger, Ethereum, Hedera Hashgraph, etc.) without altering the APIs associated with data sharing. Here, transaction types can be data requests. Through a transparent, secure methodology for logging transactions, SDF can allow various entities to write entries into a verifiable record of information, and a community of authorized users can control how the record of information is amended and updated. An audit trail capability can enable tracking of access authorization for transactions, or records, at any place and time in a network, and/or through a string of networks and hosts. The latter function can provide a critical layer of data security to records, data elements, and/or intelligence products, while allowing universal access. The nodes simultaneously verify and record data access by users to allow tracking of data access at a granular level and shared via a virtual shared ledger with peers or those with a need to know.

SDF can extend a platform to facilitate data discovery. For example, a SDF can improve discovery through integration of data virtualization and/or cataloguing components within the secure data fabric.

Audit trail visualization can allow federation of transactional data, which enables robust details through graph representation. Embodiments can integrate several graphical algorithms, which can allow for further analysis and anomaly detection within audit logs. An auditing capability can reveal who, what, when, where, why, and how data is used. Reports can be generated by the system, by user type, user role, etc. Reports can be made available through, e.g., the administrative portal for the system owner following configuration of reporting structure and content as needed for IT or others.

A SDF can be an integration of various functionalities. In some embodiments, major functionalities can be generally grouped into data sharing, data access, data discovery, data lineage, and audit trail visualization. Data sharing in a SDF can enable data owners to define how to share their data internally and/or externally. Sharing policies can be decoupled and abstracted from physical data sources. Multi-dimensional authorization policies can be utilized for sharing data. Data access can utilize a granular role-based access control (RBAC) and/or ABAC. Authorization from authentication can be decoupled. Data access can also, or alternatively, utilize a zero-trust access policy and/or digital signatures. Data discovery can enable users with rich search and discovery capabilities. Discovery of data, whether the data source is physical or virtual, can be automated. A SDF can support data discovery of all types and formats, as well as from a variety of data sources, e.g. SQL, NoSQL, File Systems, etc. Audit trail visualization can allow graphical visualization of interactive multi-dimensional filtering, search, and audit analysis. It can provide real-time, human-friendly graphical layouts that can be synchronized with maps, charts, and/or timelines. Zero-trust framework can also be implemented to achieve reports of all transactions with authorization details including administrative actions.

A SDF can be implementation as a multi-layer, multi-level secure data-sharing system and/or software. The SDF can be implemented using a microservices-based architecture. That provides REST (representational state transfer) API-based integration interface. Because some SDF embodiments are designed to be applied to various application contexts, it can be architected to be portable, platform-independent, and vendor-neutral. To achieve this, SDF can utilize adapter patterns. An adapter pattern in this context means developing in a manner such that underlying technology can be interchanged without altering the user-facing APIs.

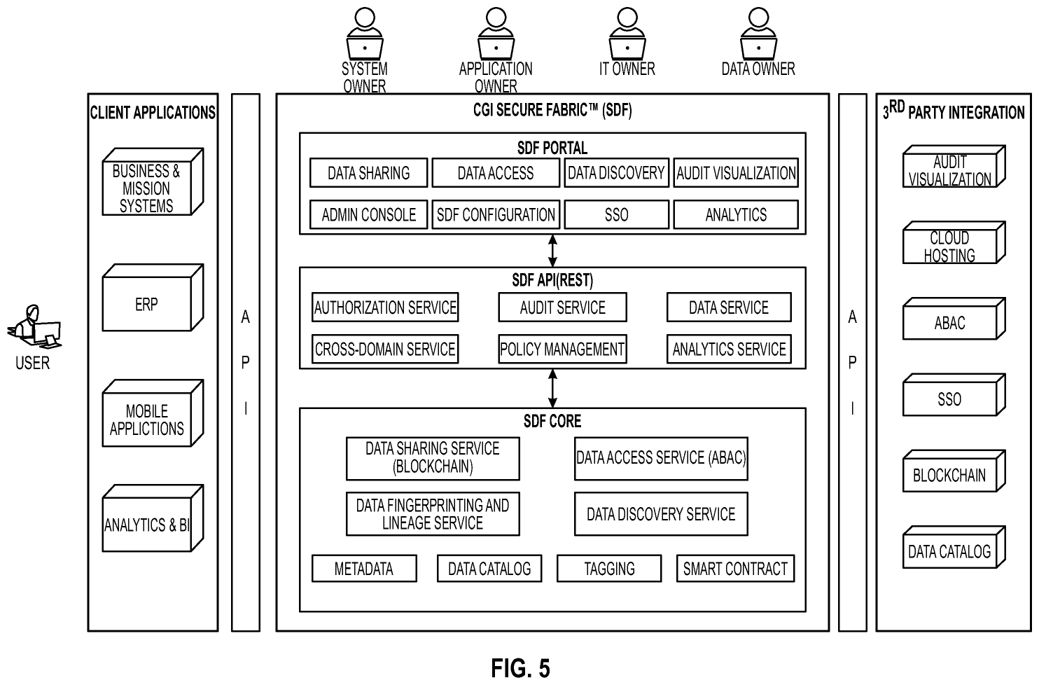

FIG. 5 illustrates one example of a SDF architecture. The SDF reference architecture can provide a logical view of the three-tier architecture, agnostic to tools, technologies, vendors, and platforms. This API-driven microservices architecture can provide integration mechanisms for organizational applications as well as third-party tool integration. Additionally, an administrative console can utilize APIs to provide administrative functionalities to system owners. Organization applications can be systems ranging from business and mission critical applications to enterprise resource planning (ERP) systems, and/or mobile applications. SDF portal can provide a console for a system administrator to configure SDF to point to their data sources, enterprise directory, define policies, and/or view audit trail analytics. SDF API layers can provide REST APIs to interact with the front end of SDF core services. Core services and/or core capabilities can be integrated with external data sources. SDF can implement microservices with, e.g., NodeJS, Golang and/or Java programming languages, while using React for a front-end user interface (UI).

A SDF can have cross-domain topology. For example, a SDF can provides cross-domain (e.g. (Classified) high side/(Unclassified) low side) capabilities. The SDF can complement and can integrate with third-party solutions, such as Oracle's Data Guard, with clear separation of concern between the two. Data Guard tools address cross-domain networking, physical data transfer, network security policies, data flow governance etc. Additionally, the SDF can achieve the same separation of concerns between any logical or physical network boundary via secure connections between nodes and endpoints. The SDF can complement and/or improve such systems or functionality by, e.g., addressing cross-domain data sharing and access. Embodiments can achieve this by, e.g., combining multiple architectural elements, such as: data sharing policies (e.g., blockchain); data access policies (e.g., ABAC); data discovery (e.g., catalog, metadata, and tags); and/or pre-approval workflow for cross-domain data access request (smart contract).

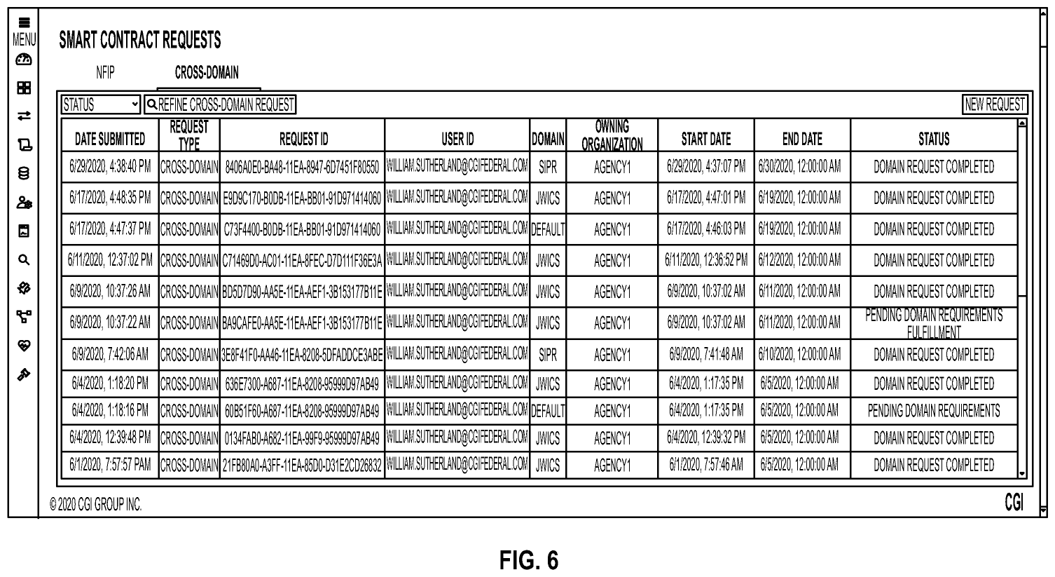

FIG. 6 depicts the SDF user interface where cross domain access request can be made and executed, e.g., via blockchain smart contract. SDF can deploy components within each domain to manage data discovery, sharing, access, and audit.

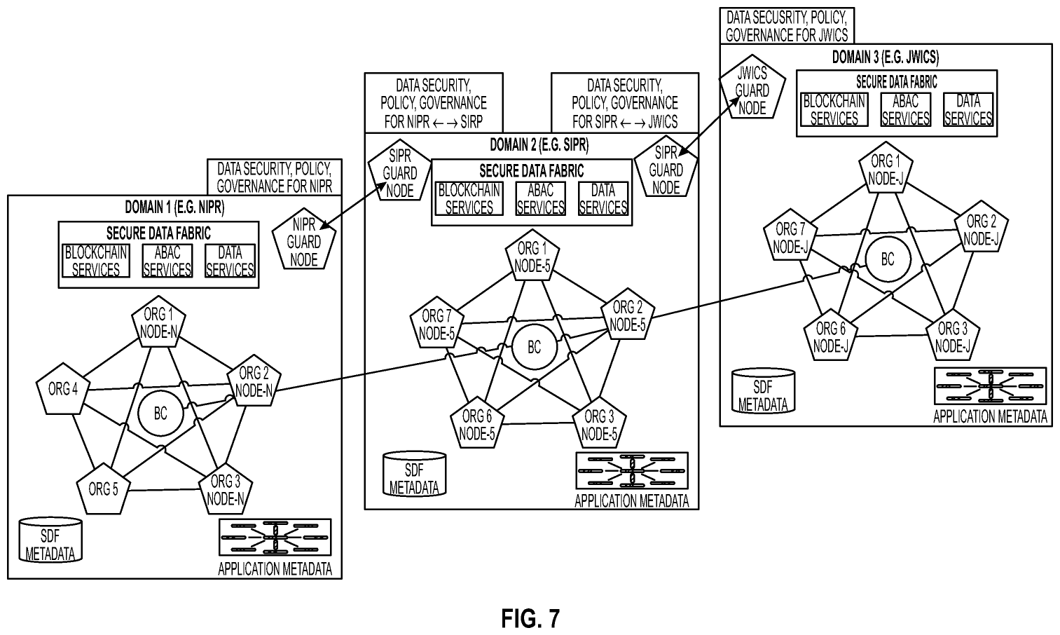

FIG. 7 illustrates a cross-domain topology. Nodes representing data sources within appropriate domains can be part of a peer-to-peer blockchain network that form the cross-domain boundaries. While a node manages the authorization to its data inside a domain, SDF components can communicate with each other to facilitate data sharing and data access across domains, as reflected in the figure.

Various embodiments can operate in different ways and with different configurations. One example can include a policy-based authorization framework. A SDF can execute a set of component-specific policies to determine authorization (i.e. allow access/deny access) to a data source and/or corresponding data elements for an incoming user request. A SDF policy framework can utilize flexible, extensible, portable and/or cumulative models, which can achieve a powerful authorization framework. A SDF policy can include delegated policies from major components, such as data sharing policies and data access policies. Such models can enable shared responsibility for authorization with separation from concerns encapsulated by each component. Policy can be made up of one or more sets of policy elements.

Each policy element can describe the subject requesting access to a resource, the type of action for the request, the environment the request is generated from, and/or the effect of the policy. A subject can be a user or non-user entity to be authenticated by the SSO component. Several examples of policy elements are shown in the figure, such as effect (allow or deny), subject (who/what is demanding access to an information asset), action (the action the subject wants to perform/do), resource (the item or information asset impacted by the action), and environment (the circumstances in which access is requested).

SDF can implement a delegated authority smart contract that is configurable through node policies to designate the authoritative (primary/elected) node with higher consensus power thus providing a mechanism for delegated authority to sign the final block during the consensus computation. This allows a set of N nodes (called consensus nodes or delegates) to cooperate in a global decentralized network where the finality of consensus can be traced through chain-of-custody, this tracing back to the authoritative (primary/elected) node. Through the delegated authority consensus smart contract, while the core consensus nodes enforce on-chain governance, the smart contract can ensure all nodes in the network, as a unique global state, view all these decisions (including transaction computation) consistently.

SDF can process an authorization request in multiple layers at multiple levels, for example when an authenticated end user makes a data request. Blockchain can provide a first-layer authorization based on, e.g., a comprehensive data sharing policy defined by a system owner. Data sharing policies can represent multi-dimensional policy framework including RBAC, ABAC attributes, security classifications, domains, environments, tags, and other factors. Each dimension can represent a policy with authorization details defined by, e.g., the system owner. A data sharing policy can determine whether a blockchain node can fulfill a request, for example whether it has data to share for the given request. In other words, it can authorize sharing its data to the end user. Each node can represent a data source and can have its own local policy, such as policies managed by its admin, e.g., a delegated admin model. Once authorized by a node, the request can then be processed by the data access authorization (ABAC policy) for the second-layer data access policy. At this level, ABAC policies can determine what data elements within an authorized data source the user has access to. In some embodiments, every data access request must pass these multiple layers of security and thereby enforce a zero-trust policy. Whether an application has internal or external data sources, SDF can leverage catalog tools, for example to use metadata for the policies.

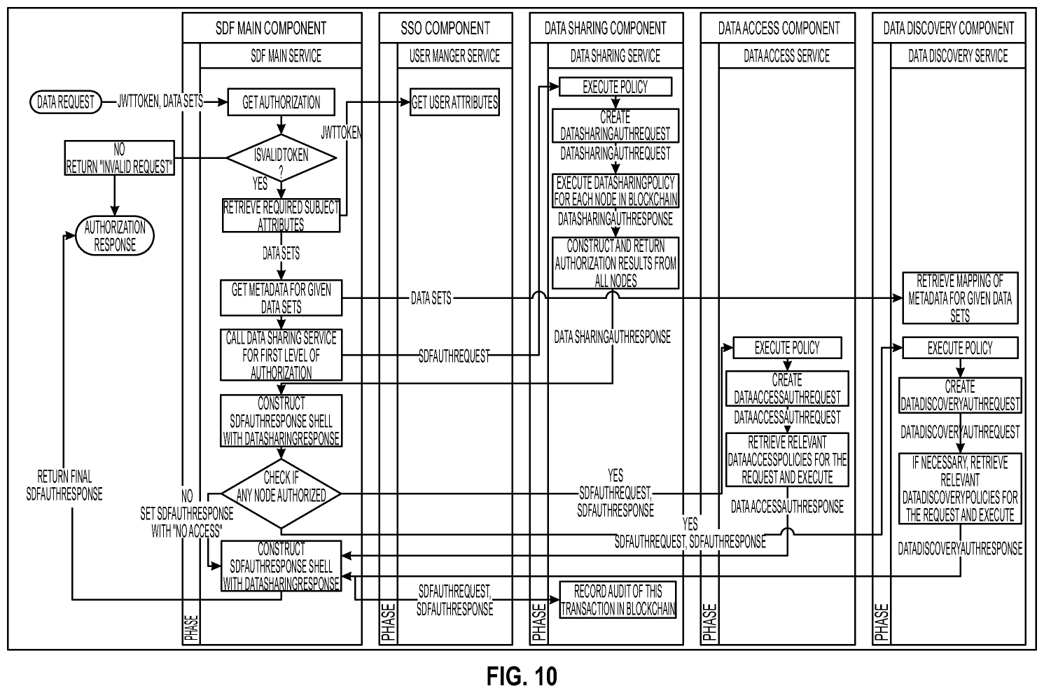

FIG. 10 illustrates an example of a handshaking flow that can be utilized in some embodiments. A user request can start with a single SDF API call that can internally collaborate with the responsible components to execute the relevant policies and return a comprehensive response indicating what data sources and what elements within the data sources are allowed for the request.

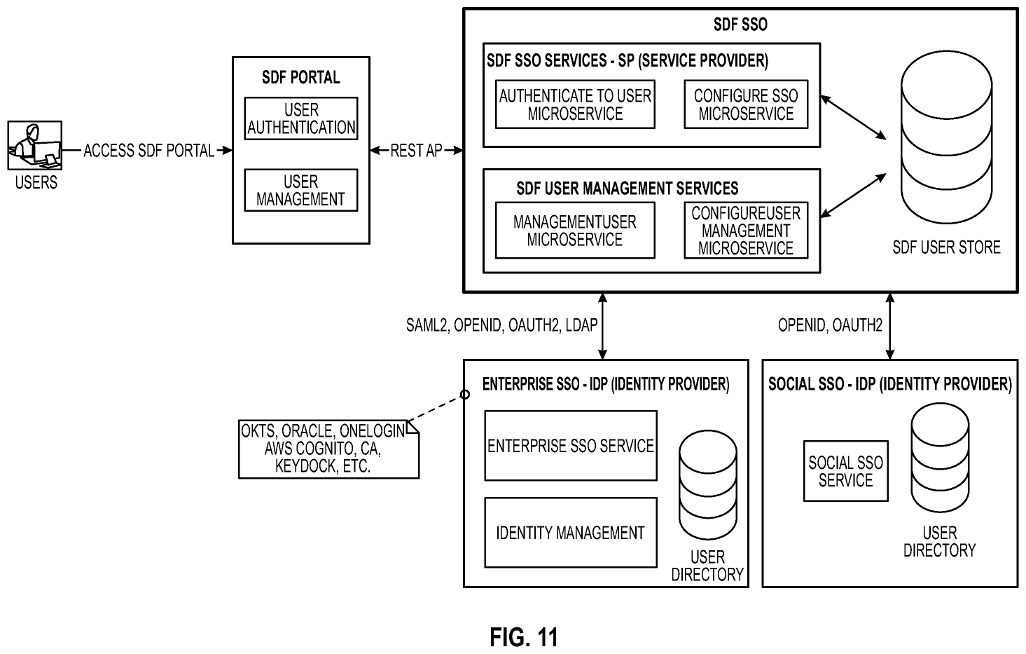

FIG. 11 illustrates an example of single sign on (SSO). A SDF can provide an interface to integrate with various platforms, including Enterprise SSO platforms, for example to provide seamless user authentication within the enterprise. SDF can provide user a management module (sub-component) for facilitating user mapping and user attribute extension, for example based on enterprise user directories. The SDF SSO component logical diagram shown in FIG. 11 illustrates a high-level logical view of the SDF SSO component in respect to Enterprise SSO.

Embodiments can provide an interface to seamlessly integrate with Enterprise SSO platforms to provide seamless user authentication. SSO can be a centralized session and user authentication service in which one set of login credentials can be used to access multiple applications. SDF can utilize multiple industry standard SSO protocol integration options with several identity providers (IDPs). SDF applications can be capable of integrating standard SSO protocols such as SAML 2.0, OpenID, OAuth 2.0, LDAP, etc.

User authentication can touch on a number of concepts. For example, several are provided for an embodiment shown in Table I.

TABLE I

| Item | Description |
|---|---|
| SDF user | A user who accesses SDF applications |
| SDF portal | A web portal used as landing page |
| SDF SSO-SP | A collection of microservices implemented to interact |
| | with Enterprise SSO Service provider (IDP) |
| Enterprise SSO- | An enterprise SSO IDP platform that can authenticate |
| IDP provider | users and provide response to SDF-SSO-SP |
| Social SSO-IDP | A social SSO IDP platform that can authenticate |
| provider | users and provide response to SDF-SSO-SP. |

Aspects of the user authentication module for an exemplary embodiment are provided in Table II.

TABLE II

| Service Name | Authenticate User |
|---|---|
| Description | A REST microservice that can interact with SDF |
| | portal for SSO user authentication |
| Usage | The REST API can be called from the SDF portal |
| | during user authentication, and the API can facilitate |
| | authentication through an Enterprise SSO platform |
| Input | JSON object that contains user data |
| Output | JSON object with authentication token and user |
| | attributes |

Aspects of the SSO module for an exemplary embodiment are provided in Table III.

TABLE III

| Service Name | Configure SSO |
|---|---|
| Description | A REST microservice that can interact with SDF |
| | portal for SSO configuration |
| Usage | The REST API can be called from SDF portal admin |
| | user interface-SSO configuration screen |
| Input | JSON object that contains related data for each |
| | authentication type, SAML 2.0, OpenID, OAuth 2.9, |
| | LDAP, and parameters can include IDP provide |
| | name, SP provider name, entity ID, host URL, IDP |
| | metadata, etc. |
| Output | JSON object with configuration success or failure |
| | response |

The protocol-based user authentication flow diagram illustrates an interaction between a SDF SSO application and an Enterprise SSO identity provider for successful high-level authentication steps. In an embodiment, when a SDF user accesses the SDF portal, the SDF SSO component sends http authentication request to Enterprise SSO, which prompts the user for appropriate login credential. Once the user provides a valid credential and the enterprise SSO authenticates the user successfully, it generates SAML token and redirects back to the SDF SSO, which displays the landing SDF portal-landing page.

Embodiments can also address user management. For example, a SDF can provide a user management module (sub-component) for facilitating user attributes that are specific to SDF. The SDF user management module can rely on the enterprise user directory for providing key user attributes and SDF can add additional attributes (extended attributes) that are specific to SDF in the local SDF user store. These additional SDF user attributes can be attributes that are essential for implementing business logic inside other SDF components such as ABAC. The user management module can interact with an enterprise user directory to collect core user attributes during SSO authentication where user attributes can be passed as parameters. A SDF user management component can interact with and retrieve user attributes as needed from enterprise user directory through service API calls or other mechanisms that are available.

User management can touch on a number of concepts. For example, several are provided for an embodiment shown in Table IV.

TABLE IV

| Item | Description |
|---|---|
| SDF user | A user who accesses SDF applications |
| SDF portal | A web portal used as landing page |
| SDF user | A collection of microservices implemented to |
| management | interact with Enterprise SSO directory service |
| services | identity provider (IDP) |
| Enterprise SSO- | An enterprise SSO IDP platform that can |
| IDP provider | authenticate users and provide response to SDF- |
| | SSO-SP |
| Social SSO-IDP | A social SSO IDP platform that can authenticate |
| provider | users and provide response to SDF-SSO-SP |

Aspects of the user management module for an exemplary embodiment are provided in Table V.

TABLE V

| Service Name | Configure User Management |
|---|---|
| Description | A REST microservice that can interact with SDF |
| | portal for SSO user management configuration |
| Usage | The REST API can be called from SDF portal admin |
| | user interface - user management configuration |
| | screen |
| Input | JSON object that contains SSO IDP provider user |
| | directory, and parameters can include directory type, |
| | provider name, SP provider name, host URI, etc. |
| Output | JSON object with configuration success or failure |
| | response |

Aspects of the manage user module for an exemplary embodiment are provided in Table VI.

TABLE VI

| Service Name | Manage User |
|---|---|
| Description | A REST microservice that can interact with SDF |
| | portal for SSO user management |
| Usage | The REST API can be called from SDF portal admin |
| | user interface - user management screen |
| Input | JSON object that can contain user attributes. For |
| | POST and Put operations, user attributes that are |
| | part of SSO IDP provider user directory need not be |
| | modified. Typically, only extended attributes that |
| | are used in SDF scope are added or modified |
| Output | JSON object with user attribute modification or |
| | view success or failure response |

Upon successful authentication via SSO, users can be assigned a unique cryptographic key, if not already associated. That key can be utilized to digitally sign any transaction performed within the SDF. This digital signature provides non-repudiation, such that at any point in the future transaction authenticity can be verified by any member of the network. An embodiment of SDF can either utilize a single-use key from a hierarchically deterministic (HD) wallet or be bound to an organizational public key that is stored in an on-chain registry.

Embodiments can include a data sharing component, such as blockchain. For example, a SDF can utilize blockchain to authorize users and/or ABAC to provide users data access. The network can save the blockchain and audit activities on chain while, for example, saving a hash to the data that was searched so one can trace the lineage and authenticity of data while allowing the owner to maintain control and reducing the need for costly compute and storage solutions. The particular configuration can be a governance decision, allowing for scalability of the blockchain network and helping increase the performance. Generally speaking, the more data that is kept on chain, the more computational power and storage necessary to process blockchain transactions and the more costly the network O&M. By using a blockchain network embodiments achieve further benefits by using the smart contract feature, which addresses long-standing issues of user requested cross-domain searches. The smart contract feature can provide authorization, access, and auditability of requests, and can be integrated with existing technologies such as Data Guard solutions with clear separation of concern between the two. Data Guard tools typically address cross-domain networking, physical data transfer, network security policies, data flow governance. While embodiment can include such tools, a preferred embodiment complements those tools by addressing cross-domain data sharing and access. For example, each node in the blockchain can represents an organization that has data to share. A blockchain for the authorization module can be based on an organization data sharing policy. The data sharing policy can determine whether a node can fulfill a search/discovery request, i.e. whether it has data to share for the given request, and can authorize sharing its data to the end user. The data sharing policy can be multi-dimensional. For example, it can rely on combinations to user profile, RBAC, ABAC, resources, security classifications, releasability, and other factors as deemed necessary. Each node can have its own policy managed by, e.g., its admin to achieve a delegated admin model.

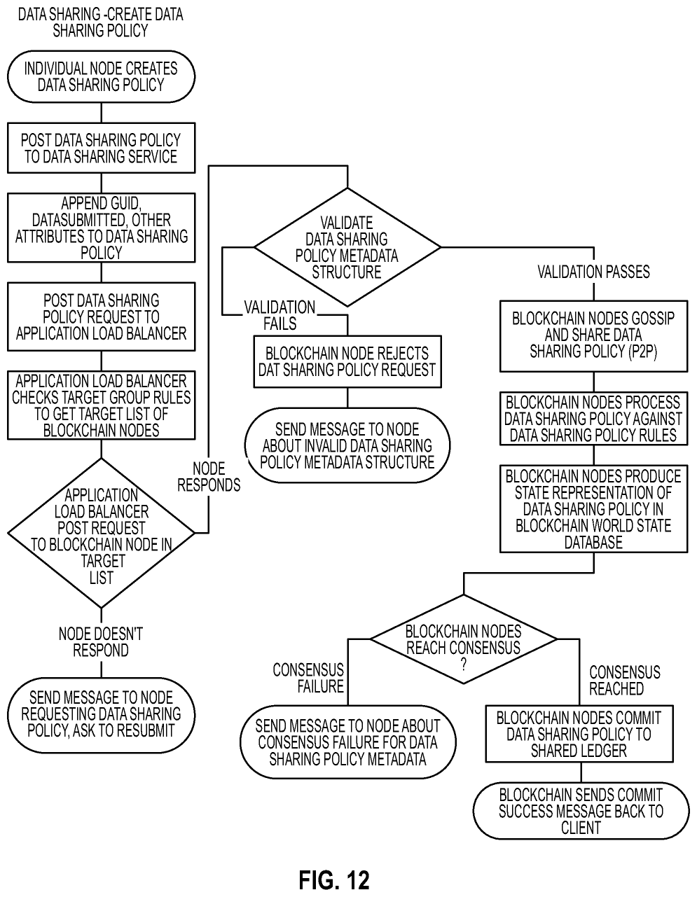

FIG. 12 illustrates a data sharing policy model. In some embodiments, each data sharing node in the data sharing network can customize data sharing policies to determine which nodes they allow data sharing. A base set of attributes of the data sharing policy can be provided out-of-the-box. Based on the configuration and policies permitting, users can add additional attributes to add more flexibility and security to out-of-the-box data sharing policy schemas. Collection of data sharing policies can form the data sharing rules for the data sharing network. Data sharing policies can be used in the data sharing component to grant blockchain-based authorization. Such authorization can determine whether a member of the data sharing network (a node on the network) is authorized to share data with another member (another node on the network).

Application programming interfaces (APIs) can be provided to integrate various functionality. For example, data sharing policy APIs can be implemented.

Data Sharing Policy - Transactions

| | | |
|---|---|---|
| Transaction type | REST API | REST API Type |
| Policy | /datasharing/policy | POST |

Data Sharing Policy Queries

| | | |
|---|---|---|
| Query type | REST API | REST API Type |
| Policy | /datasharing/policy/ :id | GET |
| Policy Paged | /datasharing//policy/page/ | GET |
| Results | numrows?orderby=[asc\|desc] | |

Embodiments can be implemented with various data structures, such as the data sharing policy sample data structure shown below.

```
// Data Sharing Policy - Sample
{
  ″PolicyId″: ″″,
  ″DateSubmitted″: ″″,
  ″SharingNodeId″: ″NodeId0″,
  ″ShareWithNodeIds″: [″NodeId1″, ″NodeId2″, ″NodeId3″],
  ″SourceDomain″: ″″,
  ″OrganizationName″: ″″,
  ″Version″: ″″,
  ″SupportedSharingElements″: {
    ″UserRoles″: [ ],
    ″UserAttributes″: {
      ″Email″: ″″,
      ″Name″: ″″,
      ″Project″: [ ],
      ″Clearance″: [ ],
      ″Rank″: [ ] ,
      ″JobTitle″: [ ]
    },
    ″DataTags″: [ ],
    ″DataClassifications″: { ],
    ″DataReleasability″: [ ]
  }
}
```

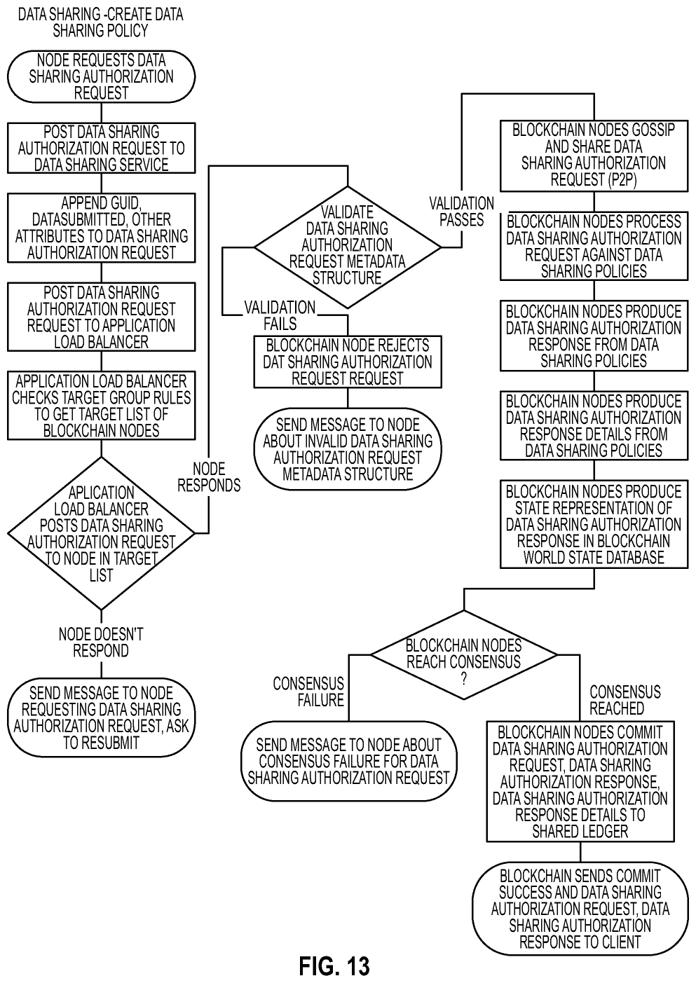

With further reference to FIG. 12 as well as to FIG. 13, data sharing authorization flows can include various steps and/or modules. For example, an application, system, or user can make a request for a set of data. This data request can be in the form of a query, but is not limited to queries alone. The request can come from any set of user interfaces, application programmable interfaces (APIs), remote procedure calls (RPC), REST endpoints, etc. Attributes for the application, system, or user, along with other attributes organized into dimensions, can be combined with the data request to form a multi-dimensional structure of attributes. A data request can be assigned a global unique identifier (GUID) or a unique universal identifier (UUID) to uniquely identify the request, along with the date submitted. The data sharing authorization request can be broadcast to a distributed ledger technology, typically a blockchain network, with multiple nodes listening for requests. By way of a variant, the data sharing authorization request can be made to a microservice, serving a central access point for the SDF system. The incoming data sharing authorization request, along with the data sharing authorization response, can be stored in an immutable data storage system. Preliminary validation can occur as to the structure of the data request before it is considered by the other nodes in the DLT or blockchain network. Upon validation of a request, it can be shared to one or more (including all) nodes in the DLT or blockchain network for consideration. In some embodiments, once a data request has been approved by, e.g., ⅔ of nodes (can be configurable), the request is added to a block and shared to each node. Each node in the blockchain network can run a state machine to process the incoming requests. In a preferred optional embodiment, ⅔ of all nodes must compute the same result for the request for the network to commit the result. This can provide Byzantine Fault tolerance. The state machine can be responsible for calculating the permit or deny to the individual attributes of the data request by running the request against the data access policies which were published to the blockchain. After the state machine calculates the collection of permit/deny results of the multi-dimensional attributes—the collection of permit/deny results, block height, off-chain hash pointers to off-chain immutable data objects, and other cryptographic information is stored in the block along with the data request. The block and state machine responses can be stored on each node's shared ledger, and consensus can be reached when ⅔ of the network's nodes calculate the same response to the data request. In should be appreciated that both the ratio and the number of nodes calculating the response can be optimized (statically and/or dynamically) for a given context, for preference, or for business or speed reasons. Once the data authorization response has been published and/or stored in the shared ledger, all microservices, processes, and/or APIs involved in the downstream processing or transmission of data between the sharing parties can reference this data authorization response to authorize what data elements can be shared.

Further security cryptographic validity of the data sharing authorization request and data sharing authorization response objects stored in the DLT or blockchain network can be achieved. For example, a Merkle proof can be utilized to validate a Merkle tree, which can be created from the data sharing authorization request and data sharing authorization response objects. Any downstream microservice, process, and/or API can leverage this additional security by, for example, running a light client and validating the cryptographic integrity of the Data sharing authorization request and data sharing authorization response before processing.

Downstream microservices, processes, and/or APIs can post logging transactions to the DLT and/or blockchain network, for example by referencing the data sharing authorization request and data sharing authorization response, providing audit logging of the downstream processing or transmission of data. This can allow cryptographic guarantees to be extended to the microservice, process, or API.

Security appliances or highly secure computing platforms can be integrated into SDF to allow further end-to-end physical security in transmission of data between parties. The appliances can also commit audit logging of transmission of data, allowing the cryptographic guarantees to be extended to the security appliance or highly secure computing platform. Further examples are shown below:

Data Sharing Authorization Transactions

| | | |
|---|---|---|
| Transaction type | REST API | REST API Type |
| Authorization | /datasharing/authorization/ | POST |
| request | request | |

Data Sharing Authorization Queries

| | | |
|---|---|---|
| Query type | REST API | REST |
| | | API Type |
| Authorization | /datasharing/authorization/ | GET |
| response | response/:id | |
| Authorization | /datasharing | GET |
| response pages | /authorization/response/ | |
| results | page/numrows?orderby= | |
| | [asc\|desc] | |
| Authorization | /datasharing | GET |
| audit | /authorization/audit/:id | |
| Authorization | /datasharing | GET |
| audit | /authorization/audit/page | |
| Authorization | /datasharing | GET |
| audit paged | /authorization/audit/page/ | |
| results | numrows?orderby= | |
| | [asc\|desc] | |

Aspects of the data sharing authorization can be implemented with various data structures, such as the sample data structures shown below.

```
// Sample - Data Sharing Authorization Request
{
  ″UserId″: ″2551f8a8-f138-4b61-b6bf-2605d6845ec4″,
  ″OrganizationName″: ″DIA″,
  ″Domain″: ″NIPR″,
  ″SourceIP″: ″127.0.0.1″,
  ″UserRoles″: [″ODNI Analyst″],
  ″UserAttributes″: {
    ″Email″: ″mar.thompson@cgifederal.com″,
    ″Name″: ″Mark Thompson″,
    ″Project″: [″DIA MARS″],
    ″Clearance″: [″TS″],
    ″Rank″: [″Major″],
    ″JobTitle″: [″Analyst″]
  },
  ″DataTags″: [ ],
  ″DataClassifications″: [ ],
  ″DataReleasability″: [ ],
  ″QueryHash″: ″0x5bd77dbf7c800000″
}
Sample - Data Sharing Authorization Response
  ″AuthorizationResponse″: {
    ″authorizationRequestId″: ″00ecf410-bb9d-11ea-b36c-b5a1f8efaba1″,
      ″blockHeight″: 1413,
      ″nodeResponses″: [
        {
          ″domain″: ″JWICS″,
          ″nodeId″: ″agency4″,
          ″policyResponse″: false
        },
        {
          ″domain″: ″JWICS″,
          ″nodeId″: ″agency5″,
          ″policyResponse″: false
        },
        {
          ″domain″: ″NIPR″,
          ″nodeId″: ″agency1″,
          ″policyResponse″: true
        },
        {
          ″domain″: ″NIPR″,
          ″nodeId″: ″agency3″,
          ″policyResponse″: true
        },
        {
          ″domain″: ″SIPR″,
          ″nodeId″: ″agency4″,
          ″policyResponse″: false
        },
        {
          ″domain″: ″JWICS″,
          ″nodeId″: ″agency1″,
          ″policyResponse″: false
        },
        {
          ″domain″: ″NIPR″,
          ″nodeId″: ″agency2″,
          ″policyResponse″: true
        }, ...
      ],
      ″policyDetailsHash″:
″9076121CFE3D576475DEDB243A5373C6DD3E4F6026C8C4C-
34D634FF3AEE8770B″
    }
Sample - Data Sharing Authorization Response Detail
″AuthResponseDetails″: {
  ″AuthRequestId″: ″00ecf410-bb9d-11ea-b36c-b5a1f8efaba1″,
  ″BlockHeight″: 1413,
  ″Responses″: [ {
    ″Domain″: ″NIPR″,
    ″NodeId″: ″agency1″,
    ″OrganizationName″: ″FBI″,
    ″DetailResults″: {
      ″DataClassifications″: true,
      ″DataReleasability″: false,
      ″DataTags″: false,
      ″ShareWithOrganizations″: true,
      ″UserAttributes″: true,
      ″UserRoles″: true
    }
    }, {
      ″Domain″: ″NIPR″,
      ″NodeId″: ″agency2″,
      ″OrganizationName″: ″CIA″,
      ″DetailResults″: {
        ″DataClassifications″: true,
        ″DataReleasability″: false,
        ″DataTags″: true,
        ″ShareWithOrganizations″: true,
        ″UserAttributes″: true,
        ″UserRoles″: true
      }
    }, {
      ″Domain″: ″NIPR″,
      ″NodeId″: ″agency3″,
      ″OrganizationName″: ″ODNI″,
      ″DetailResults″: {
        ″DataClassifications″: true,
        ″DataReleasability″: true,
        ″DataTags″: true,
        ″ShareWithOrganizations″: true,
        ″UserAttributes″: true,
        ″UserRoles″: true
      }
    } , {
      ″Domain″: ″NIPR″,
      ″NodeId″: ″agency4″,
      ″OrganizationName″: ″DIA″,
      ″DetailResults″: {
        ″DataClassifications″: true,
        ″DataReleasability″: true,
        ″DataTags″: true,
        ″ShareWithOrganizations″: true,
        ″UserAttributes″: true,
        ″UserRoles″: true
      }
    } , {
      ″Domain″: ″NIPR″,
      ″NodeId″: ″agency5″,
      ″OrganizationName″: ″DIA″,
      ″DetailResults″: {
        ″DataClassifications″: true,
        ″DataReleasability″: true,
        ″DataTags″: true,
        ″ShareWithOrganizations″: true,
        ″UserAttributes″: true,
        ″UserRoles″: true
      }
    }
  }
}
```

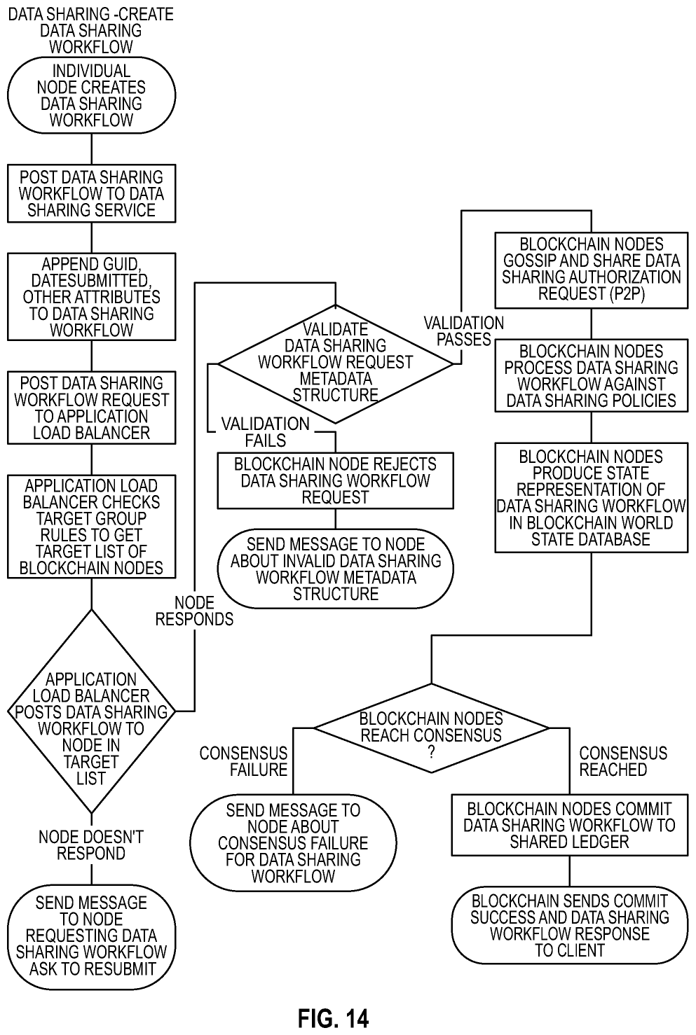

FIG. 14 illustrates an example of a data sharing workflow. Data sharing workflows can allow for multi-step, multi-approval workflows to be executed as smart contracts in the data sharing network. Data sharing workflows can be considered a contract between a member of the data sharing network (a node on the network) and other members of the network that grants authorization for data sharing in advanced scenarios. Advanced scenarios can include cross-domain data sharing. All members who participate in the data sharing workflow digitally assign the workflow template to approve their participation before the workflow is executed. Steps in the data sharing workflow can be digitally signed by multiple participants in the workflow, based on workflow configuration. Steps in the data sharing workflow can be of type requirements, fulfillment, and/or approval. Additional step types can be added. Additionally, workflow tools can be integrated and/or replace the example workflow as desired.

A node who participates in the data sharing workflow can initiate the workflow to request advanced authorization beyond what data sharing policies provide. Steps in the data sharing workflow can be time-based completion based on duration rules setup in each step. Participants in the workflow can approve or deny each step in the workflow. If a step is set to deny, the workflow process can be halted.

All Steps in the workflow process can be digitally signed for full immutable audit traceability. Once all workflow steps are completed and approved, the data sharing workflow can be combined with an existing data sharing workflow policy to grant advanced authorization. This advanced authorization can be based on time duration.

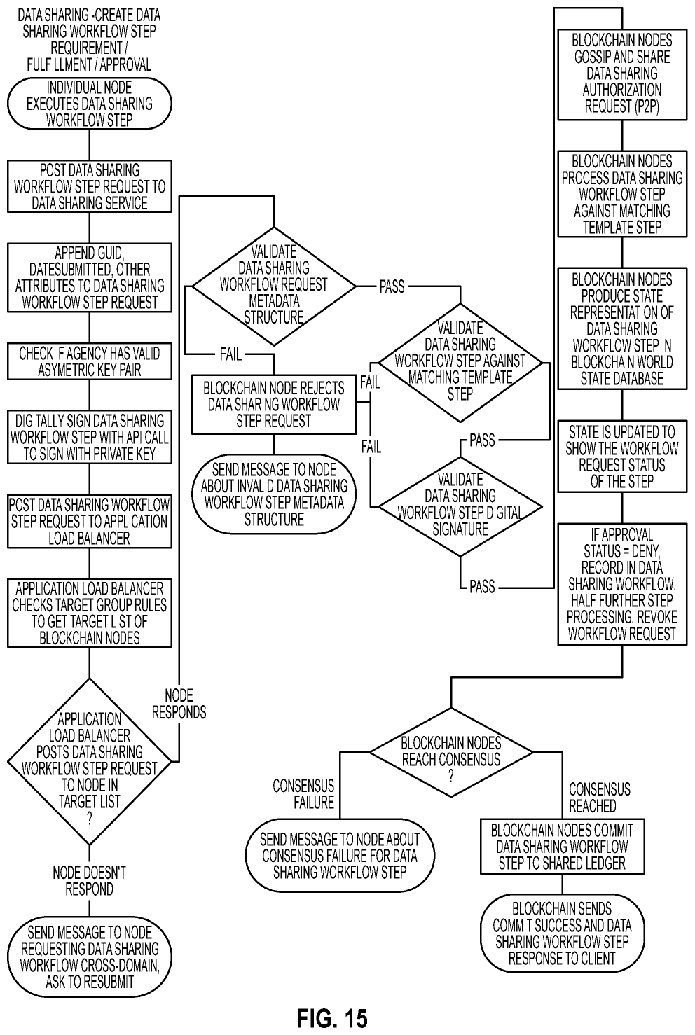

FIG. 15 illustrates another data sharing workflow. In this particular embodiment, a create data sharing workflow shows various steps, including for requirements, fulfillment, and approval.

Further examples are shown below:

Data Sharing Workflow Transactions

| | | REST |
|---|---|---|
| Transaction type | REST API | API Type |
| Add workflow | /datasharing/workflow/ | POST |
| template | template/add | |
| Revoke workflow | /datasharing/workflow/ | POST |
| template | template/revoke | |
| Digitally sign & | /datasharing/workflow/ | POST |
| approve workflow | template/approve | |
| template | | |
| Start workflow | /datasharing/workflow/start/ | POST |
| Add digital | /datasharing/workflow/step/ | POST |
| signatures to step | sign | |
| Approve step | /datasharing/workflow/step/ | POST |
| | approve | |
| Fulfill step | /datasharing/workflow/step/ | POST |
| | fulfill | |

Data Sharing Workflow Queries

| | | REST |
|---|---|---|
| Query type | REST API | API Type |
| Workflow | /datasharing/workflow/ | GET |
| status request | status/:id | |
| Get workflow | /datasharing/workflow/ | GET |
| template | template/:id | |
| Get workflow | /datasharing/workflow/ | GET |
| template | template/requirements/:id | |
| requirements | | |
| Get workflow | /datasharing | GET |
| template | /workflow/template/ | |
| fulfillment | fulfillment/:id | |
| Get workflow | /datasharing | GET |
| template | /workflow/template/ | |
| approval | approval/:id | |

A sample JSON object for data sharing workflow is shown below.

//Data Sharing Workflow - Sample JSON
{
″WorkflowId″: <GUID>,
″SharingDomain″: ″″,
″SharingNodeId″: ″NodeId0″,
″ShareWithNodeIds″: [ {″Domain″: ″″, ″NodeId″: ″″}, ...],
″StartDateTime″: ″″,
″EndDateTime″: ″″,
″Duration″: ″″,
″Requirements″: [ {″RequirementId″, ″Requirements″: [″″, ...] }, ...]
″RevokeAllowed″: true | false,
″AuthorizeByDate″: ″″,
″AuthorizeByDuration″: ″″,
″NodeSignatures″: [ {″NodeId″, ″DigitalSignatureTxID″, ″DateSigned″}, ...]
″DigitalSignaturesShareWithNodeIds″: [″″, ...],
″Steps″: [
{
″StepId″: 1,
″StepType″: ″[Requirements | Fulfillment | Approval]″,
″RequestFromNodeId″: ″″,
″DigitalSignaturesRequired″: [″NodeId0″, ″NodeId1″, ...],
″Requirements″: [ {″RequirementId″, ″FulfillByDateTimeStamp″: ″″,
″FulfillByDuration″: ″″}, ... ],
″Fulfillment″: [ {″RequirementId″, ″CompletedDateTimeStamp″:
″Status″: true/false}, ... ],
″FulfillmentStepId″: 2
},
{
″StepId″: 2,
″StepType″: ″[Requirements | Fulfillment | Approval]″,
″RequestFromNodeId″: ″″,
″DigitalSignaturesRequired″: [″NodeId0″, ″NodeId1″, ...]
″Fulfillment″: [ {″RequirementId″, ″CompletedDateTimeStamp″: ″″,
″Status″: true/false}, ... ],
″ApprovalStepId″: 3
},
{
″StepId″: 3,
″StepType″: ″[Requirements | Fulfillment | Approval]″,
″RequestFromNodeId″: ″″,
″DigitalSignaturesRequired″: [″NodeId0″, ″NodeId1″, ...],
″Approval″: [ {″StepId″, ″WorkflowInstanceId″″: ″Approval″: true/false},
... ],
}
]
}

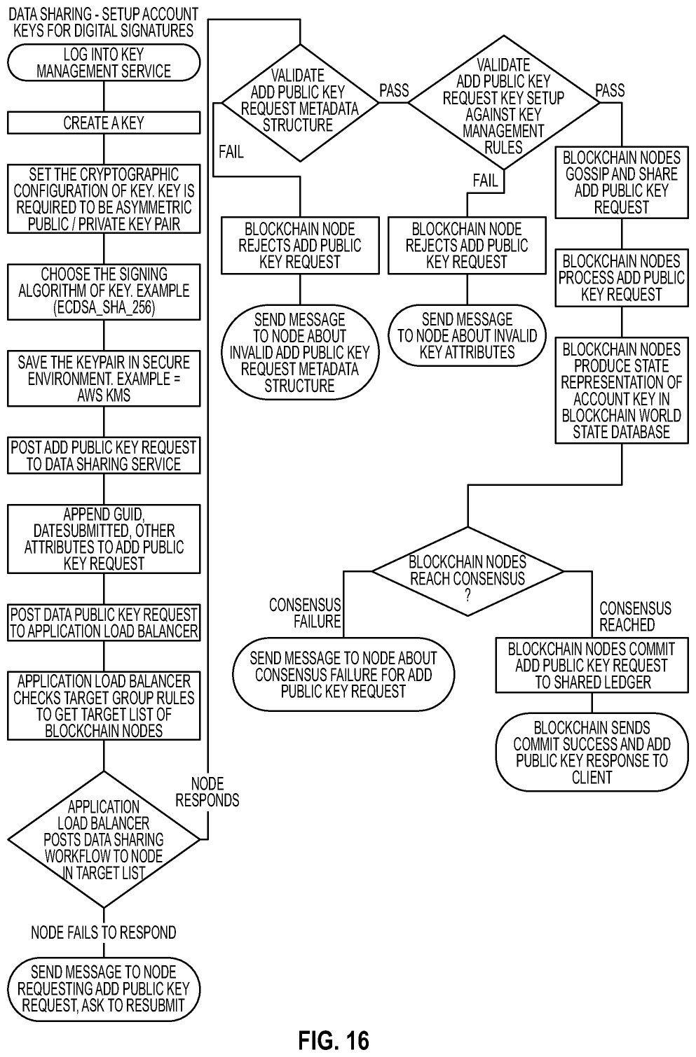

FIG. 16 illustrates exemplary aspects of account key management. A data sharing component can include an account key management that can allow for setup, processing, and/or controls of asymmetric key pairs, which can be utilized to digitally sign transactions. A data sharing component can apply rules, constraints, and policies against what types of keys are allowed for digital signatures. This can allow customization of the level of security provided. The data sharing component can check a digital signature of a transaction to validate the source of the transaction is approved by the data sharing network, which is preferably a blockchain network. If the key used to digitally sign the transaction is not approved by the data sharing network, the transaction can be automatically rejected in real-time. APIs for key management can include the following examples.

Key Management Transactions

| | | |
|---|---|---|
| Transaction type | REST API | REST API Type |
| Add public key | /datasharing/keyMgmt/add | POST |

Key Management Queries

| | | REST |
|---|---|---|
| Query type | REST API | API Type |
| Get public key | /datasharing/keyMgmt/key/:id | GET |
| Get public keys | /datasharing/keyMgmt | GET |
| paged results | /key/:page/:numrows?orderby= | |
| | [asc\|desc] | |

A sample data structure for key management are provided below.

```
{
  ″AgencyId″: ″Agency1″,
  ″KeyId″: ″4b522807-3579-474e-99cf-3d1a10151959″,
  ″PublicKey″:
″MFkwEwYHKoZIzj0CAQYIKoZIzj0DAQcDQgAEU9kbe/
y8dThRjhGSY6Jip/Ve1+pQ6YSg==″
}
```

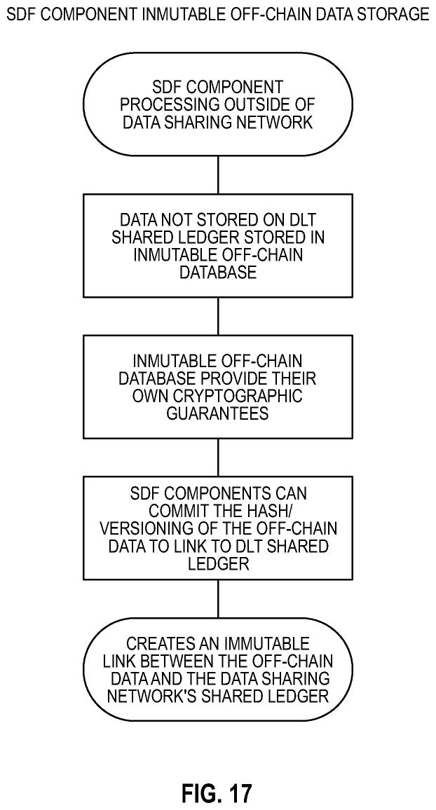

FIG. 17 illustrates a component for immutable off-chain data storage, which can be linked to a blockchain shared ledger. Data used in SDF that is not stored on a DLT shared ledger can be stored in an immutable off-chain storage database. The immutable database can provide its own cryptographic guarantees to data add to the database. Examples of SDF components publishing their component data in immutable off-chain storage can include: data access policies (ABAC); data discovery metadata (data source metadata); and SSO data stores. Embodiments can leverage the hash and/or versioning information that immutable off-chain databases create. A SDF can post such hash/versioning information to the DLT shared ledger, creating an immutable chain between the off-chain database and the DLT shared ledger.

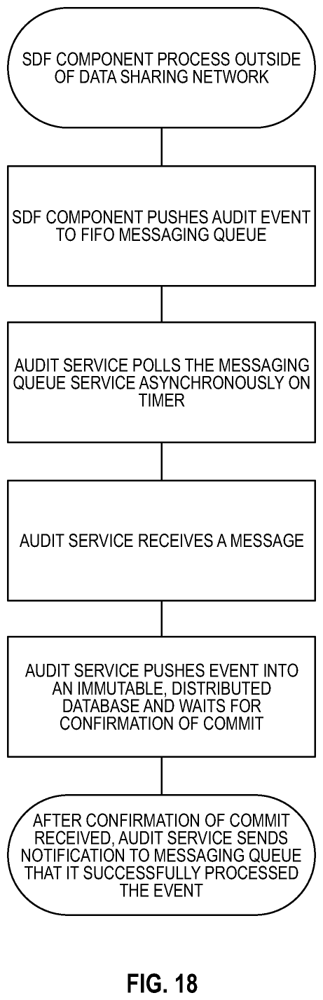

FIG. 18 illustrates an asynchronous messaging queue process for component logging that can be utilized by certain embodiments. A SDF data sharing component can provide integration with asynchronous messaging queue services to allow asynchronous event processing. This can allow SDF to show immutable audit tracking of component processing outside the data sharing component. An example of an algorithm or workflow can include: logging events capture in off-chain immutable database; SDF component posts audit events to messaging queue service; data sharing service polls the messaging queue service asynchronously; when a message is received; adds logging events to blockchain shared ledger; system throughput; performance improvements.

Embodiments can utilize various cryptographic validation techniques and/or algorithms, for example to achieve end-to-end validation of an immutable audit trail. These can include Merkle trees, which can be used in blockchains and off-chain immutable databases.

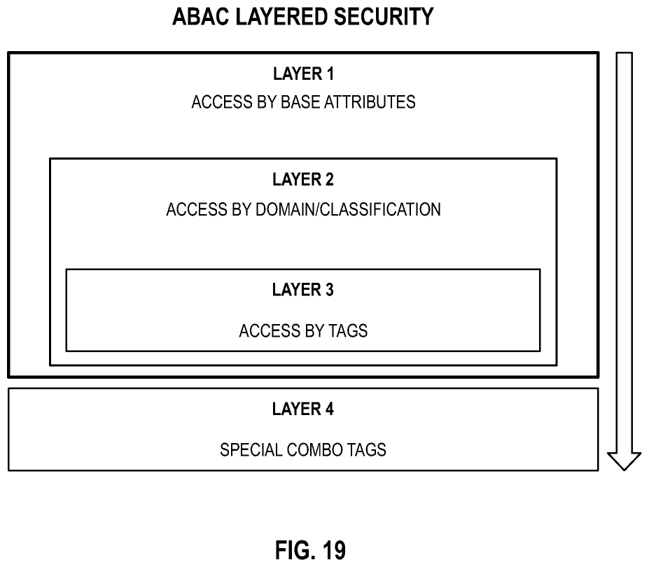

FIG. 19 illustrates data access component (ABAC) layered security. The SDF data access component can be responsible for providing granular access control to every data request based on the predefined data access policies. In a preferred embodiment, this is the second and most granular layer of defense for SDF and can enforce a zero-trust security assertion. The data sharing policies can be defined with the ABAC framework by, for example, utilizing user attributes and/or resource attributes. SDF can be configured to leverage the industry best practices for ABAC framework and therefore can be integrated with multiple ABAC products in order to support various client applications.

ABAC defines a data access control paradigm whereby access rights are granted to users through the use of policies that combine attributes together. The policies can use any type of attributes (user attributes, resource attributes, object, environment attributes etc.). This model supports Boolean logic, for example where rules contain “IF, THEN” statements about who is making the request, the resource, and the action. Unlike RBAC, which employs pre-defined roles that carry a specific set of privileges associated with them and to which subjects are assigned, the key difference with ABAC is the concept of policies that express a complex Boolean rule set that can evaluate many different attributes. Within the data access component, SDF implements ABAC policies in multiple layers keeping security and performance in mind. It is designed to process incoming data requests from simplest form to more complex structure. A request can include only a set of base user attributes, or it can contain additional conditions such as domain and environmental attributes along with tags and advance metadata. ABAC policies are designed to handle this complexity in a layered approach so that data owners can define the policies in incremental manner. User attributes are obtained from the SSO component while the metadata and tags are obtained from the data discovery component. FIG. 19 depicts the multi-layered ABAC security policy.

Data access authorization can be extended from the SDF policy-based authorization framework and can include ABAC specific rules. An example of a logical flow of ABAC policy execution that some embodiments can implement is as follows:

Policy Enforcement Point (PEP) intercepts and transfers it based on pre-defined logic; Policy Decision Point (PDP) utilizes pre-defined policies and data from the ABAC micro-services (PIP, DDS, ARS) in order to produce decisive policies or statement;

Authorization data is returned with an API Response;

(PEP)—Policy Enforcement Point (Gateway for Interception);

(PDP)—Policy Decision Point (Evaluates and Issues Authorization);

(DDS)—Data Distribution Service (Data Source/Metadata Management);

(PIP)—Policy Information Point (Policy Store); and

(ARS)—Attribute Registry Service (User, Action, Object Attributes)

A SDF administrative console can provides data owners a set of UI to define and manage the ABAC policies. The data access component can provide a set of policy management capabilities: Policy Backup, Policy Restoration, Batch Deleting Policies, Batch Creating Policies,

Automatic Multi-Policy Creation, Dependency Updates, and/or Policy Templates.

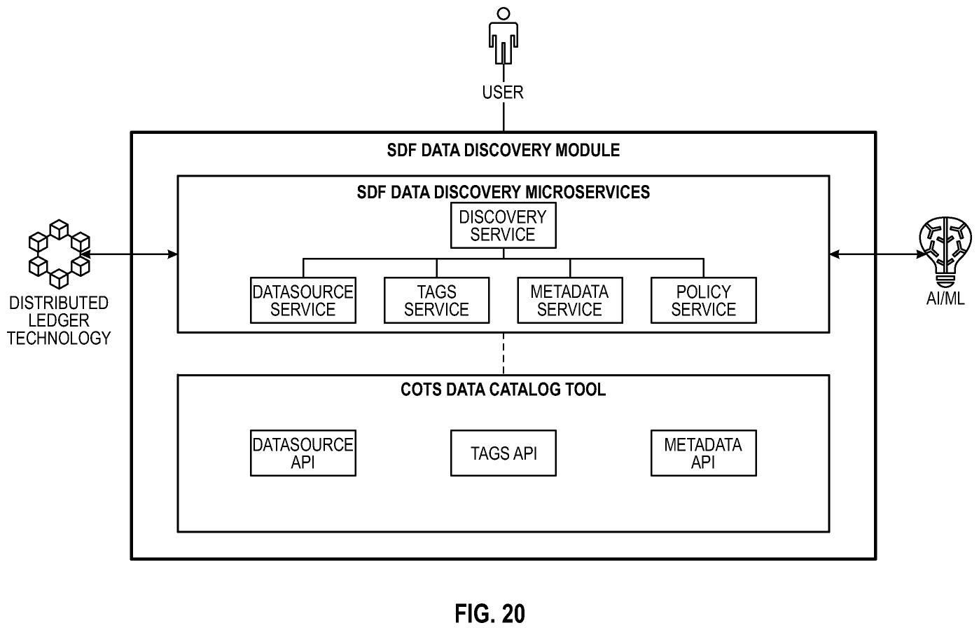

FIG. 20 illustrates a data discovery module or component, which can include a data catalog. A SDF can enable users to easily discover new data. It can also give data owners the ability to curate datasets for consumption. This can be achieved by, e.g., placing a wrapper around a COTS data catalog tool. By leveraging the innate power of a data catalog tool, and wrapping APIs with additional business logic the SDF can enhance security, integrate with other modules, and streamline tasks of the data owner. Various aspects and considerations of the data discovery module are provided below in Tables VII through XI.

TABLE VII

| Item | Description |
|---|---|
| SDF user | A user, application, or system that is accessing |
| | features of the SDF Data Discovery Module. This |
| | can be an end user or the data owner. |
| Distributed | Usage: Enables Data Owners to define how to |
| ledger | share their data internally or externally. Sharing |
| technology | policies can be decoupled and abstracted from the |
| | physical data sources. Multi-dimensional |
| | authorization policies for sharing data. |
| Machine | Usage: ML/AI can be applied to aide in the |
| learning/ | curation of data discovery artifacts such as |
| artificial | suggestions of tags to apply to a resource, |
| intelligence | analysis of usage trends to suggest additional |
| | modifications to the catalog that would benefit |
| | user discovery of data, and the deduplication of |
| | redundant data sources. |

TABLE VIII

| Service | |
|---|---|
| Name | Discovery service |
| Descrip- | REST service entry point, and orchestration service |
| tion | for all requests coming to the SDF Discovery Module |
| | from an external, integrated application. May be |
| | expanded by ML/AI to facilitate natural language |
| | processing of user requests to map to data catalog |
| | objects. |
| Input | JSON object that can contain details about the |
| | requesting user and resources attempting to be |
| | accessed |
| Output | JSON object that can contain data catalog objects |
| | either matching tags and/or metadata |

TABLE IX

| Service | |
|---|---|
| Name | Tag service |
| Descrip- | REST microservice for management of data catalog |
| tion | tags by a data owner. May also be called via the |
| | Discovery Service for external requests. HTTP |
| | method invocation will determine operation to be |
| | performed. May be invoked by the data access module |
| | during policy creation to enable cell-level security of |
| | a resource. |
| Input | JSON object that will contain listing of tags and |
| | requisite tag details in the event of tag definition or |
| | modification. |
| Output | In the event of a GET request, a JSON object containing |
| | matching data catalog entries based upon the searched |
| | tags. For all other requests, a JSON object containing |
| | status of intended operation and matched objects. |

TABLE X

| Service | |
|---|---|
| Name | Metadata service |
| Descrip- | REST microservice for management of data catalog |
| tion | metadata by a data owner. May also be called via the |
| | Discovery Service for external requests. HTTP method |
| | invocation will determine operation to be performed. |
| | May be invoked by the data access module during |
| | policy creation to enable cell-level security of a |
| | resource. |
| Input | JSON object that can contain listing of metadata and |
| | requisite metadata details in the event of metadata |
| | definition or modification. |
| Output | In the event of a GET request, a JSON object containing |
| | matching data catalog entries based upon the searched |
| | metadata. For all other requests, a JSON object |
| | containing status of intended operation and matched |
| | objects. |

TABLE X

| Service | |
|---|---|
| Name | Policy service |
| Descrip- | REST microservice for management of data catalog |
| tion | policies by a data owner. May also be called via the |
| | Discovery Service for external requests to enact |
| | additional filtering of return based on SDF consumer |
| | guidelines. HTTP method invocation will determine |
| | operation to be performed. |
| Input | JSON object that can contain a desired policy to |
| | enforce where a policy is comprised of matching |
| | attributes regarding a user, a resource the policy will |
| | be applied against, and an action to grant or deny |
| | discoverability of the resource to the defined user |
| | attributes. |
| Output | In the event of a GET request, a JSON object |
| | containing policy entries based upon the searched |
| | resources. For all other requests, a JSON object |
| | containing status of intended operation for the |
| | creation, deletion, or modification of a discovery |
| | policy. |

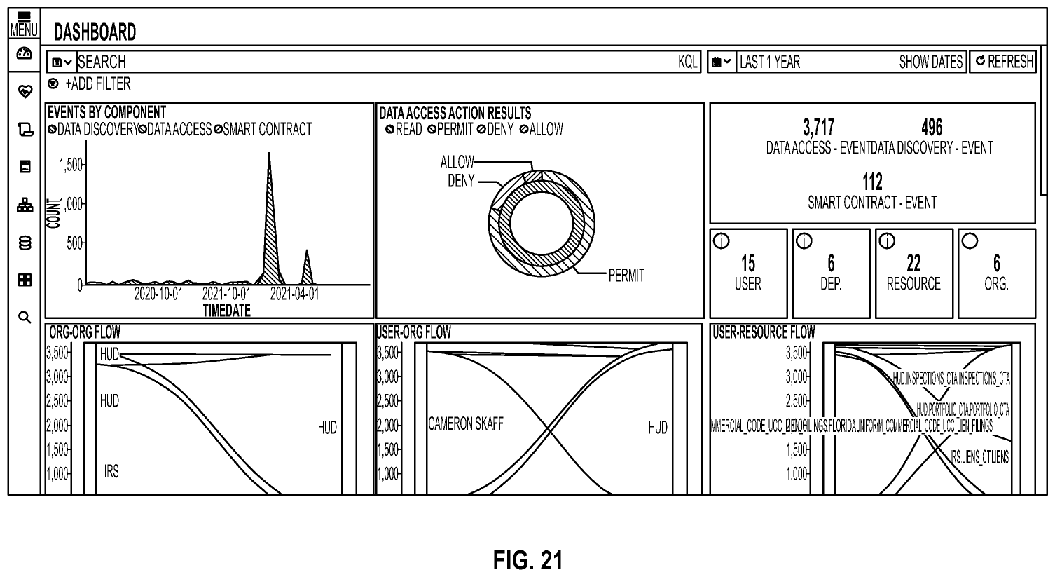

FIG. 21 depicts a sample screen of an audit visualization tool. An audit trail can be visualized using graph database or any data visualization software. Graph visualization can allow federation of audit data, which can enable robust audit details through graph representation enhancing the auditability of data. Embodiments can have several graph algorithms integrated allowing for further analysis and anomaly detection within the audit logs. The auditing capability of the SDF can reveal who, what, when, where, why, and how data is used.

Embodiments can provide a loosely coupled integration between the SDF, data virtualization, and data catalog to restrict user and system access to connected data sources across multiple networks, as well as transformed, consumable data made available in memory to analytical applications. Embodiments can integrate a data catalog with an ABAC security policy and/or data virtualization components. Such integrations can enable limiting access to metadata within the data catalog based on a user's attributes and the ABAC policy. In turn, this enforcement only allows the user to access, view, and maintain the centralized catalog and glossary of data within the data virtualization platform for which they have access. Below are some of the features that can be integrated into the SDF Audit module:

data sources federated into a single, unified model;

graph visualization from RDBMS i.e. no need to convert to Graph database;

scalable, high performance, and flexible advanced graph layout and graph analytics;

incremental model population; and

authorization details can include data sharing policy response (e.g. blockchain) and data access policy response (e.g. ABAC) by each node.

As shown in the example of FIG. 21, a detail audit trace of user activity can be quickly and efficiently presented to a requester, from the original request including the query, data sharing authorization by each blockchain node, ABAC response with allowed/denied data elements, and the query response returned back along with timestamp.

FIG. 1 depicts a logical view of interaction via REST APIs between various components of a SDF. Each component can implement its functionalities with service-oriented architecture design pattern, and they can use a microservices implementation model. Microservice can be considered an architectural style that structures an application as a collection of services that are: (a) highly maintainable and testable, (b) loosely coupled, (c) independently deployable, and (d) organized around business capabilities.

SDF embodiments can expose its capabilities with REST APIs, which can be securely managed with an API gateway. The API gateway can act as the front door to the backend services of SDF by publishing only the required interfaces with validation of input and output parameters. Each incoming request is validated to ensure it is coming from an authenticated source with a valid session token. Internally, SDF components can also interact with each other via APIs to ensure modularity, high cohesion, loose coupling, data encapsulation and other sound design principles. All APIs define input and output in JSON format.

Embodiments can be implemented in a computer environment. For example, a computer can implement the algorithms and perform functions directed by programs stored in a computer-readable medium. Embodiments can take the form of hardware, software, or a combination of software and hardware. Embodiments can take the form of a computer-program product that includes computer-useable instructions embodied on one or more computer-readable media.

Techniques, methods, and systems described herein can be implemented in part or in whole using computer-based systems and methods. Additionally, computer-based systems and methods can be used to augment or enhance the functionality, increase the speed at which the functions can be performed, and provide additional features and aspects as a part of or in addition to those described herein.

Such hardware can include a general-purpose computer, a server, network, and/or cloud infrastructure and can have internal and/or external memory for storing data and programs such as an operating system (e.g., DOS, Windows2000™, Windows XP™, Windows NT™, Windows 7™, Windows8™, Windows 8.1™, Windows10™, OS/2, UNIX, Linux, Android, or iOS) and one or more application programs. Examples of application programs can include computer programs implementing the techniques described herein for customization, authoring applications (e.g., word processing programs, database programs, spreadsheet programs, or graphics programs) capable of generating documents or other electronic content; client applications (e.g., an Internet Service Provider (ISP) client, an e-mail client, short message service (SMS) client, or an instant messaging (IM) client) capable of communicating with devices, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP). One or more of the application programs can be installed on the internal or external storage of the general-purpose computer. Alternatively, application programs can be externally stored in or performed by one or more device(s) external to the general-purpose computer.

The computer preferably includes input/output interfaces that enables wired or wireless connection to various devices. In one implementation, a processor-based system of the general-purpose computer can include a main memory, preferably random access memory (RAM), and can also include secondary memory, which may be a tangible computer-readable medium. The tangible computer-readable medium memory can include, for example, a hard disk drive or a removable storage drive, a flash-based storage system or solid-state drive, a floppy disk drive, a magnetic tape drive, an optical disk drive (Blu-Ray, DVD, CD drive), magnetic tape, standalone RAM disks, drive, etc. The removable storage drive can read from or write to a removable storage medium. A removable storage medium can include a disk, magnetic tape, optical disk (Blu-Ray disc, DVD, CD) a memory card (CompactFlash card, Secure Digital card, Memory Stick), etc., which can be removed from the storage drive used to perform read and write operations. As will be appreciated, the removable storage medium can include computer software or data.

In alternative embodiments, the tangible computer-readable medium memory can include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or flash memory) and associated socket, and other removable storage units and interfaces, which allow software and data to be transferred from the removable storage unit to the computer system.

The server can include the general-purpose computer discussed above or a series of containerized applications running on commodity or cloud-hosted hardware. The SDF can be implemented within a network, for example, the Internet, the World Wide Web, WANs, LANs, analog or digital wired and wireless networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link can include communication pathways that enable communications through one or more networks.

All of the methods and systems disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope or the invention. In addition, from the foregoing it will be seen that this invention is one well adapted to attain all the ends and objects set forth above, together with other advantages. It will be understood that certain features and sub-combinations are of utility and may be employed without reference to other features and sub-combinations. This is contemplated and within the scope of the appended claims. All such similar substitutes and modifications apparent to those skilled in the art are deemed to be within the spirit and scope of the invention as defined by the appended claims.

We claim:

1. A security platform, comprising:
an immutable data storage medium communicatively coupled to a network;
a data sharing node communicatively coupled to the network;
a central processing unit and a memory, wherein said memory includes a software,
wherein the software is configured to implement a blockchain and an ABAC module.

2. The security platform of claim 1, further comprising an administrative console configured to control blockchain-authorization-based data sharing control and access policies and to control ABAC policies of the network.

3. The security platform of claim 2, wherein the ABAC policies include a multi-layered ABAC security policy, and wherein the immutable data storage medium is separate from the blockchain.

4. The security platform of claim 3, wherein the immutable data storage medium and the data sharing node are each stored within a single database.

5. The security platform of claim 3, wherein at least one of the immutable data storage medium and the data sharing node are stored at multiple locations across the network.

6. The secure platform of claim 1, further comprising:
a data discovery search interface; and
a microservices-based access control module configured to dynamically evaluate digital security policies for a secure data fabric.

7. The secure platform of claim 1, further comprising a secure data fabric based on a cross-domain topology model.

8. The secure platform of claim 1, further comprising a user management module configured to control user attributes of a secure data fabric.

9. The secure platform of claim 1, further comprising an audit module configured to trace data lineage and data authenticity.

10. The secure platform of claim 9, wherein the audit module is configured to generate an audit trail of access authorization throughout the network.

11. The secure platform of claim 1, further comprising a cryptographic module configured to sign an atomic data transaction using a private-public key pair.

12. The secure platform of claim 1, further comprising an end-user interface,
wherein the software further comprises a smart contract module, and
wherein the end-user interface is configured to manage the smart contract for data sharing.

13. The secure platform of claim 12, further comprising a delegated authority smart contract that is configurable through node policies to designate an authoritative (primary/elected) node with a higher consensus power thus providing a mechanism for delegated authority to sign a final block during a consensus computation.

14. A blockchain-based method for implementing a secure data fabric, comprising:
providing an immutable data storage medium, wherein the immutable data storage medium is configured to communicate with a network;
providing a data sharing node having a blockchain, wherein the data sharing node is configured to communicate with the network;
implementing an attribute-based access control to create a secure data sharing environment.

15. The method of claim 14, further comprising storing data access policies and metadata in the immutable data storage medium.

16. The method of claim 15, storing, in the data sharing node, data associated with the metadata according to the data access policies.

17. The method of claim 16, wherein the data access policies are ABAC policies and include a multi-layered ABAC security policy.

18. The method of claim 17, further comprising evaluating access to the data using the multi-layered ABAC security policy.

19. The method of claim 14, further comprising generating an audit trail of access authorization in the network.

20. The method of claim 14, further comprising cryptographically signing an atomic data transaction using a private-public key pair.
